(19) United States
(12) Patent Application Publication
(10) Pub. No.: US 2003/0026626 A1
(43) Pub. Date: Feb. 6, 2003

(54) Image forming apparatus for forming image on tab-sheet

(75) Inventors: Hidenori Sunada, Ibaraki (JP); Yoshihito Osari, Chiba (JP); Akinobu Nishikata, Chiba (JP); Nobuo Sekiguchi, Ibaraki (JP); Tadaaki Saida, Chiba (JP); Yuichiro Maeda, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/200,975

(22) Filed: Jul. 24, 2002

(30) Foreign Application Priority Data
Jul. 26, 2001 (JP) 225288/2001(PAT.

(51) Int. Cl. G03G 15/00

(52) U.S. Cl. 399/82; 399/83; 399/382

(57) ABSTRACT

An image forming apparatus capable of printing images on tab-sheets as well as on normal sheets can automatically perform a mixed printing job including image printing for the normal sheets and image printing for the tab-sheets. The apparatus makes it possible to use image information a number of times and that preparation of the image information is easy. In the apparatus, image information of a text sheet document to be printed on the text sheets and image information of a tab-sheet document to be printed on the tab-sheet are separately inputted to the apparatus and separately stored in an image memory in advance. The apparatus performs combined printing in which printing of the image information of the text sheet document stored in the image memory and printing of the image information of the tab-sheet document stored in the image memory are so combined that the printings of the pages of the tab-sheet document are inserted intervening in the printing of the text sheet document at designated page positions.

### BACKGROUND OF THE INVENTION

1. Field of the Invention

The present invention relates to an image forming apparatus that is adapted to be capable of printing images (or forming images) on recording sheets in the form of tab-sheets as well as on normal paper sheets of standard sizes, and a control method thereof.

2. Related Background Art

It is known to construct image forming apparatus, e.g. copying machines, such that they can print an image on a recording sheet in the form of a tab-sheet that has a tab (i.e. an extension for index inscription) on one edge thereof as well as on normal paper sheets of standard sizes. Furthermore, prior art documents such as Japanese Patent Application Laid-Open No. 11-292328 disclose apparatus constructed in the above-mentioned manner that are additionally provided with a so-called tab copy function. The tab copy function is a function in which if the operator sets, to an original feeding device of a copying machine, a stack of originals composed of a stack of originals recorded with images to be copied on normal sheets (such originals will be referred to as originals for text sheets hereinafter) and originals recorded with images to be copied on tab-sheets (such originals will be referred to as originals for tab-sheets hereinafter) inserted within the stack of the originals for text sheets and enter into the copying machine designation of where (i.e. at which numbers from the top or bottom) in the stack of the originals the originals for tab-sheets are inserted, the designated originals are copied on tab-sheets and the rest of the originals are copied on normal sheets. With this function, the tab-sheets on which the originals for tab-sheets are copied are automatically inserted into the stack of normal sheets on which the originals for text sheets are copied, so that the apparatus can automatically perform a mixed printing job that includes printing (or copying) of images for text sheets and printing of images for tab-sheets.

Among copying machines, recently developed digital copying machines are capable of not only reading and copying images of originals but also functioning as printers that receive image information of documents to be printed from a host apparatus through a network such as a LAN (local area network) or through an interface equipped on the machine for communication with the host apparatus so as to print the received images. Upon such printing action as a printer, the copying machine can also automatically perform a mixed printing job that includes printing of images for text sheets and printing of images for tab-sheets by following a process same as the tab copy function described above.

However, in conventional copying machine arrangements concerning the tab copy function, image information on each original in a stack of the originals, which includes a stack of originals for text sheets and originals for tab-sheets inserted therein, is successively read and printed on either a text sheet or tab-sheet, and image information that has been read once is put to use only once. In other words, it is not possible for the conventional arrangements to store image information for text sheets and image information for tab-sheets separately and put them to use independently from each other for a plurality of printing jobs. Therefore, every time the tab copy function is performed, it is necessary to prepare originals for text sheets and originals for tab-sheets anew. In addition, those originals need to be prepared as an ordered document composed of a stack of originals for text sheets with originals for tab-sheets inserted therein at appropriate segmentation positions.

### SUMMARY OF THE INVENTION

In view of the above, an object of the present invention is to make it possible, in an image forming apparatus that is capable of printing images on tab-sheets as well as on normal sheets, to automatically perform a mixed printing job that includes printing of images for text sheets and printing of images for tab-sheets, while image information can be prepared easily.

It is another object of the present invention to provide an image forming apparatus comprising a memory unit which stores image information of text sheet document to be printed on normal sheets of a standard size and image information of tab-sheet to be printed on tab-sheets, a printing unit which performs printing of the image information of the text sheet document stored in the image memory unit on normal sheets and printing of the image information of the tab-sheet document stored in the image memory on tab-sheets, and a control unit which controls the printing unit in such a way that the printing unit performs combined printing in which printing of the image information of the text sheet document stored in the image memory and printing of the image information of the tab-sheet document stored in the image memory are so combined that printing of each page of the tab-sheet document is inserted intervening in the printing of the text sheet document.

Other objects and features of the invention will be readily apparent from the following description, the drawings and claims.

### BRIEF DESCRIPTION OF THE DRAWINGS

FIG. 1 is a block diagram showing a functional construction of a digital copying machine as an embodiment of the present invention.

FIG. 2 is a schematic cross sectional view showing a mechanical construction of the digital copying machine.

FIG. 3 is a block diagram showing a construction of a control system of the digital copying machine.

FIG. 4 is a block diagram showing a construction of an image processing unit of the digital copying machine.

FIG. 5 is a drawing diagrammatically illustrating a tab document combined printing process in the digital copying machine.

FIG. 6 is a flow chart showing a control process of the tab document combined printing in the digital copying machine.

FIG. 7 illustrates a selection screen for designating a selected text sheet document in the tab document combined printing

FIG. 8 illustrates a designation screen for designating a tab-sheet inserting position in the tab document combined printing.

FIG. 9 is a diagram illustrating a manner in which the image forming position is shifted upon printing an image of a tab-sheet document on a tab-sheet in the tab document combined printing.

### DETAILED DESCRIPTION OF THE PREFERRED EMBODIMENTS

In the following an embodiment of the present invention will be described with reference to the annexed drawings. Here, descriptions will be made of an embodiment of the image forming apparatus in the form of a digital copying machine that is capable of printing (or image-forming) images on tab-sheets as well as on normal (or plain) sheets of standard sizes as recording sheets and further capable of performing combined printing of image information (which will be described later and referred to as “tab document combined printing” hereinafter) in which a document to be printed on normal sheets (hereinafter referred to as “text sheet document”) and document to be printed on tab-sheets (hereinafter referred to as “tab-sheet document”), both of which are stored in an image memory, are combined to be printed.

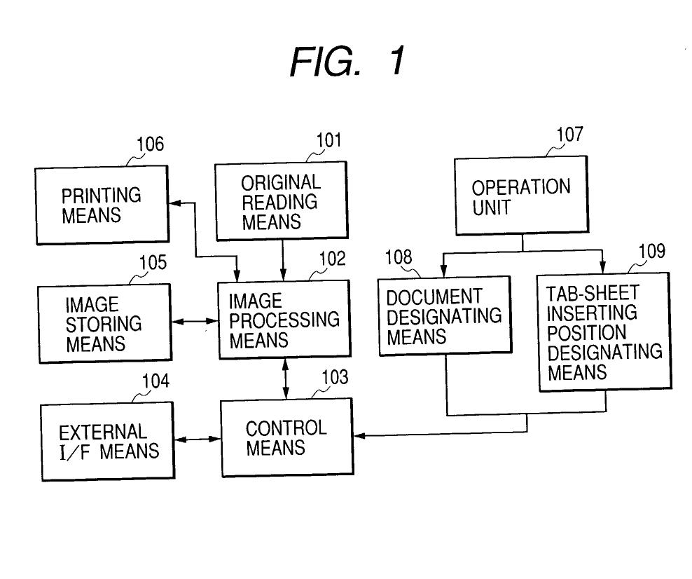

FIG. 1 shows a functional construction of the digital copying machine according to the embodiment.

In FIG. 1, reference numeral 101 denotes original reading means which reads image information on one side or both sides of each original that is set on an original table. In this embodiment, it is presumed, in connection with the tab document combined printing, that originals for text sheets and originals for tab-sheets are read separately. In other words, upon reading the text sheet document and the tab-sheet document, a document set comprised of sheets of the text sheet documents inserted with sheets of the tab-sheet documents is not prepared for reading, but a sheet stack (or group) of the text sheet document is read first and then a sheet stack (or group) of the tab-sheet document is read. Alternatively, a sheet stack (or group) of the tab-sheet document is read first and then a sheet stack (or group) of the text sheet documents is read.

Image processing means 102 processes an analog signal corresponding to image information of the originals output from the original reading means 101 to convert it into digital image information, and effects further processing on the thus obtained digital image information if necessary. The processing includes general processing required for printing (or copying) such as shading correction, under color removal, scaling (or varying magnification), rotational transformation, etc.

Reference numeral 103 denotes control means which controls the digital copying machine overall to make the machine to perform printing.

External interface means 104 conducts data communication with a host apparatus (not shown) such as personal computer or the like directly or by means of a network such as a LAN so as to receive image data of a document to be printed from the host apparatus. As to these document image data also, it is presumed, in connection with the tab document combined printing, that image data of the text sheet document and image data of the tab-sheet document are read separately. In other words, upon receiving the image data of text sheet document and tab-sheet document, image data of a document set comprised of sheets of the text sheet document inserted with sheets of the tab-sheet document is not received, but image data of a sheet stack (or group) of the text sheet document is received first and then image data of a sheet stack (or group) of the tab-sheet document is received. Alternatively, image data of a sheet stack (or group) of the tab-sheet document is received first and then image data of a sheet stack (or group) of the text sheet document is received.

Image storing means 105 stores image data of original documents (text sheet documents or tab-sheet documents) that have been read by the original reading means 101 and processed by the image processing means 102 and document image data from a host apparatus that have been received through the external interface means 104 (and processed by the image processing means 102 under the control of the control means 103). In this connection, the image data of the text sheet document and the image data of the tab-sheet document are separately input, so that they are separately stored in the image storing means 105.

Reference numeral 106 denotes printing means which prints image information that has been read out from the image storing means 105 and processed by the image processing means 102 on normal sheets or tab-sheets.

Reference numeral 107 denotes an operation unit with which the operator conducts operational entry for various setting of the digital copying machine. The operation unit 107 has a key entry unit (not shown) and a display unit for displaying operation status etc. of the copying machine.

Reference numeral 108 denotes document designating means which designates, in the tab document combined printing mode (which will be described later), one text sheet document and one tab-sheet document among at least one text sheet documents and at least one tab-sheet documents stored in the image storing means 105 in advance, in accordance with operator's designation entered through the operation unit 107.

Reference numeral 109 denotes inserting position designating means which designates, in the tab document combined printing mode (which will be described later), a page number position at which each printed page of the tab-sheet document is inserted in printed pages of the text sheet document, in accordance with operator's designation entered through the operation unit 107.

The control means 103 accesses, in the tab document combined printing mode, the image storing means 105 through the image processing means 102 so that the tab document combined printing would be performed in accordance with the designations by the document designating means 108 and inserting position designating means 109 so as to control the printing means 106 to perform the tab document combined printing.

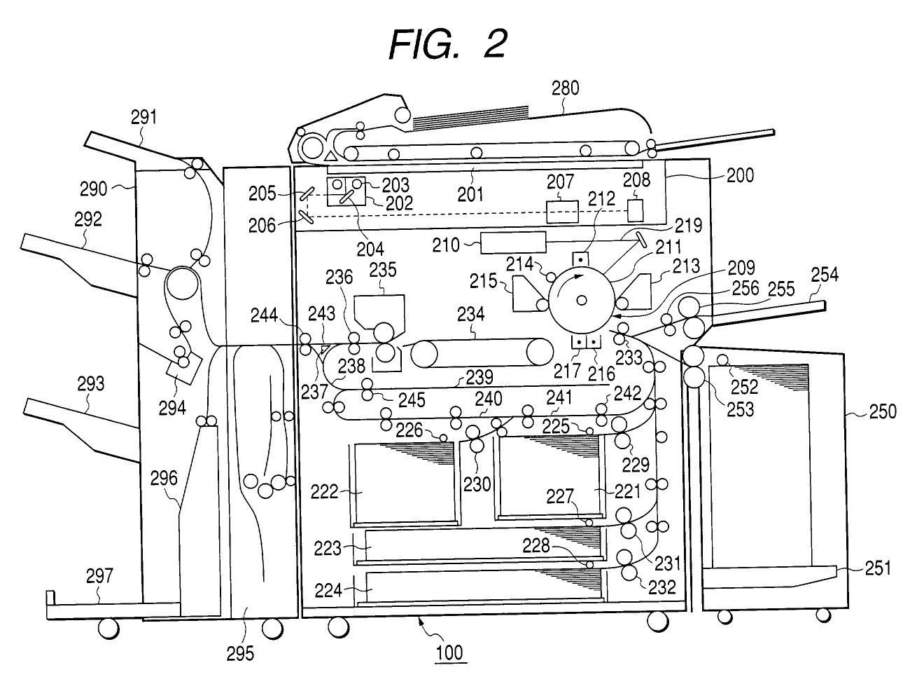

FIG. 2 shows the mechanical construction of the digital copying machine of the present embodiment. In this arrangement, a reader unit 200 comprised of members 201 to 208 is disposed in the upper portion of a body 100 of the copying machine, and an ADF (automatic original feeder) 208 is provided above the reader unit 200.

The ADF 280 feeds or forwards originals for text sheets or originals for tab-sheets set thereon onto a platen glass 201 (serving as a original table of the reader unit 200) sheet by sheet successively.

A scanner 202 comprised of a lamp 203 for illuminating the original, a scanning mirror 204, etc. is provided below the platen glass 201. The scanner 202 reciprocates in the horizontal direction in the drawing by means of a motor (not shown), so that the original on the platen glass 201 is scanned with illuminating light from the lamp 203. An image generated by the reflection light from the original is formed on a CCD sensor in an image sensor unit 208 via a scanning mirror 204, mirrors 205 and 206 and a lens 207 so as to be converted into an electrical signal. Incidentally, the reader unit 200 and the ADF 280 correspond to the original reading means 101 shown in FIG. 1.

In the body 100 of the digital copying machine, there is provided, below the reader unit 200, an image forming section 209 (constituting the printing means 106 in FIG. 1) and a recording sheet conveying mechanism.

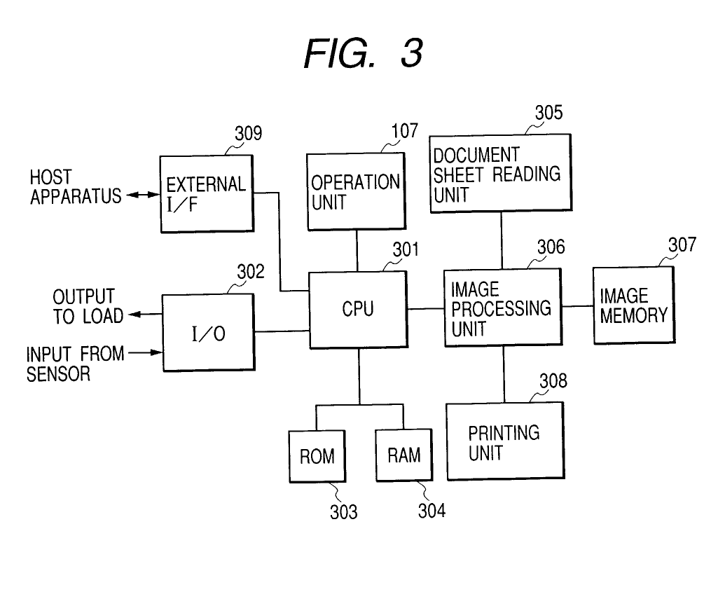

In the image forming section 209, reference numeral 210 denotes an exposure control unit comprised of a laser unit, a polygon scanner, etc. The exposure control unit 210 irradiates a photosensitive drum 211 with a laser beam 219 which is modulated based on an image signal that is generated by processing, with an image processing unit 306 in FIG. 3 (which will be described later), an electrical signal output from the image sensor unit 208.

Around the photosensitive drum 211, there is provided a primary charger 212, a developer 213, a transfer charger 216, a detach charger 217, a pre-exposure lamp 214 and a cleaning device 215. The photosensitive drum 211 is rotated by a motor (not shown) in the direction indicated by the arrow in the drawing. The photosensitive drum is charged up to a desired electric potential by the primary charger 212, and then irradiated with the laser beam 219 from the exposure control unit 210, so that an electrostatic latent image is formed on its surface. The electrostatic latent image formed on the photosensitive drum 211 is developed as a toner image by the developer 213 so as to be made visible.

On the other hand, a recording sheet is passed out from a right cassette deck 221, a left cassette deck 222, an upper cassette 223 or a lower cassette 224 by means of pickup rollers 225, 226, 227 or 228 and conveyed to the image forming section 209 by means of feed rollers 229, 230, 231 or 232. Then, the recording sheet is so forwarded by registration rollers 233 as to be in contact with the photosensitive drum 211, so that the toner image on the surface of the photosensitive drum 211 is transferred to the recording sheet by the transfer charger 216. After the transfer of the image, residual toner on the photosensitive drum is cleaned by the cleaning device 215, and residual charge is cleared by the pre-exposure lamp 214.

The recording sheet having been transferred with the image is detached from the photosensitive drum 211 by the detach charger 217 and conveyed to a fixing device 235 by a belt 234, in which the toner image is fixed by pressure and heat. After the fixing, the recording sheet is discharged from the body 100 by discharge rollers 236.

The body 100 is attached with a deck 250 which can accommodate e.g. about 4000 (four thousands) sheets of recording paper. A lifter 251 of the deck 250 moves up and down in accordance with the amount of the recording sheets in the deck 250 so that the recording sheet would be always in contact with a pickup roller 252. Recording sheets are fed into the body 100 by the pickup roller 252 and feed rollers 253.

In addition, a manual feeder 254, on which about 100 (one hundred) recording sheets can be set, is provided outside the body 100. Recording sheets set on the manual feeder 254 are fed to the image forming section 209 by rollers 255 and 256.

Among the sheet feeders mentioned above, a certain feeder(s), e.g. the manual feeder 254, cassette 223 or 224, can be set with and feed tab-sheets as well as normal sheets of standard sizes as recording sheets. Thus the specific feeder(s) is set with tab-sheets and other feeders are set with normal sheets, so that normal sheets and tab-sheets can be selectively fed to the image forming section 209 for each sheet to be printed with an image.

In FIG. 2, reference numeral 237 denotes a discharging flapper which switches the conveying route of the recording sheet passed out from discharge rollers 236 between a conveying path 238 side and a discharging path 243 side. The conveying route of the conveying path 238 side continues sequentially from the conveying path 238 to a reversing path 239 for reversing the recording sheet, a lower conveying path 240 and a re-feeding path 241. It should be noted that recording sheets are also fed to the re-feeding path 241 from the left cassette deck 222 through the feeding rollers 230. The recording sheets on the re-feeding path 241 are fed to the image forming section 209 again (i.e. “re-fed”, though those recording sheets which are supplied to the re-feeding path from the left cassettes are fed to the image forming section for the first time).

In the vicinity of the discharging flapper, there is provided discharging rollers 244, which discharge the recording sheets that have been guided by the discharging flapper 237 to the discharging path 243 side, out of the body 100.

Under the dual side printing (or coping) mode, the discharging flapper 237 is raised to an upper position so as to guide the recording sheets recorded with images on one side thereof, to the re-feeding path 241 via the conveying path 238, reversing path 239 and lower conveying path 240. At that time, after a recording sheet is pulled into the reversing path 239 to a position at which the trailing (or rear) edge of the recording sheet have been completely way out of the discharging path 238 while the recording sheet is clipped between reversing rollers 245, the reversing rollers 245 are counterturned (or reversed in its rotating direction) so as to reverse the surface of the recording sheet to pass it to the lower conveying path 240.

On the other hand, upon discharging a recording sheet out of the body 100 with the surface of the sheet reversed, the discharging flapper 237 is raised to an upper position, and after the recording sheet is pulled into the reversing path 239 to a position at which the trailing edge of the recording sheet remains in the conveying path 238, the reversing rollers 245 are countertured so as to pass the recording sheet to the discharging rollers 244 with the surface of the sheet reversed.

The body 100 is connected with a discharge processing device 290 for aligning and stapling the recording sheets discharged from the body 100. The discharge processing device 290 places and aligns the recording sheets, which are discharged sheet by sheet from the body 100, on a processing tray 294. When a copy of (or a set of) recording sheets are discharged, the discharge processing device 290 staples the stack of that copy of recording sheets and discharges it onto a discharge tray 292 or 293. The discharge tray 293 is moved up and down by a motor (not shown). Before the image forming operation starts, the discharge tray 293 is moved to a position corresponding to the processing tray 294, and the discharge tray 293 is so lowered subsequently that the top level of the stack of sheets on the discharge tray 293 aligns with the processing tray 294, as the discharged sheets accumulates on the discharge tray 293. Furthermore, the copying machine is provided with a sensor (not shown) to detect that the discharge tray 293 assumes a position at which e.g. about 2000 (two thousands) sheets are placed on the tray 293.

Reference numeral 291 denotes a sheet tray on which segmentation insert sheets to be inserted in the discharged sheets. Reference numeral 295 denotes a Z-folder for folding a discharged sheet in a Z-shape. Reference numeral 296 denotes a binding device, which performs binding by folding a discharged copy of recording sheets at its center and stapling it, whereby a bundle of sheets thus bound is discharged onto a discharge tray 297.

Next, the construction of the control system of the digital copying machine according to this embodiment will be described with reference to FIG. 3.

In FIG. 3, reference numeral 301 denotes a CPU, corresponding to the control means shown in FIG. 1, to which an input/output port 302, a ROM 303 storing a control program and a RAM 304 for serving as a work space for various processing, through the address bus and data bus.

The CPU 301 receives inputs required for controlling the digital copying machine from various sensors, such as a sensor for detecting a recording sheet position or a temperature sensor (both of which are not shown in the drawings). On the other hand, the CPU supplies outputs to various loads, such as motors, solenoids or clutches in respective sections in the copying machine. The CPU controls the inputs and outputs through the input/output port sequentially in accordance with the control program so as to execute image forming operation.

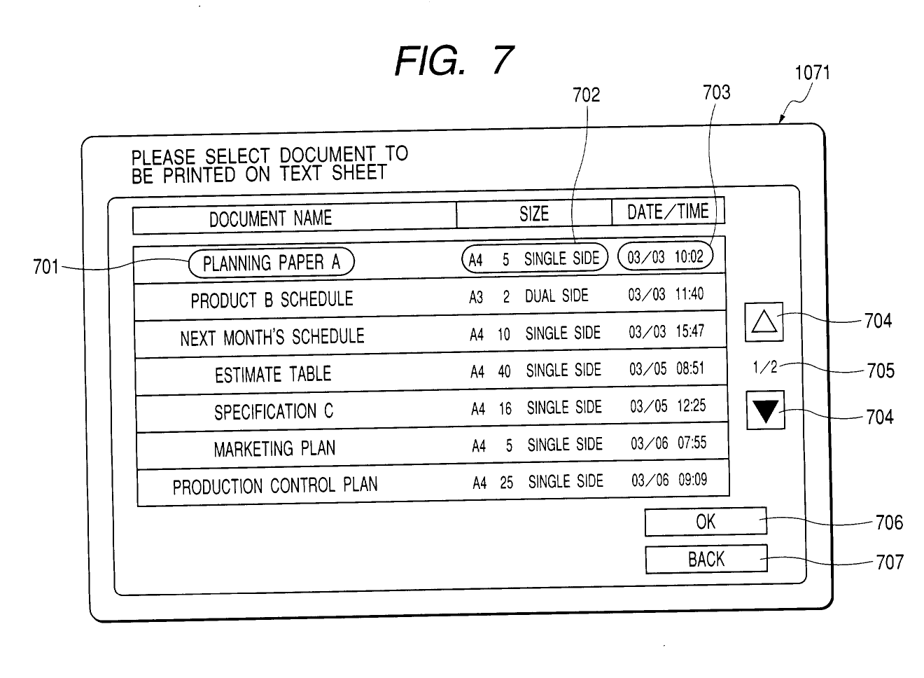

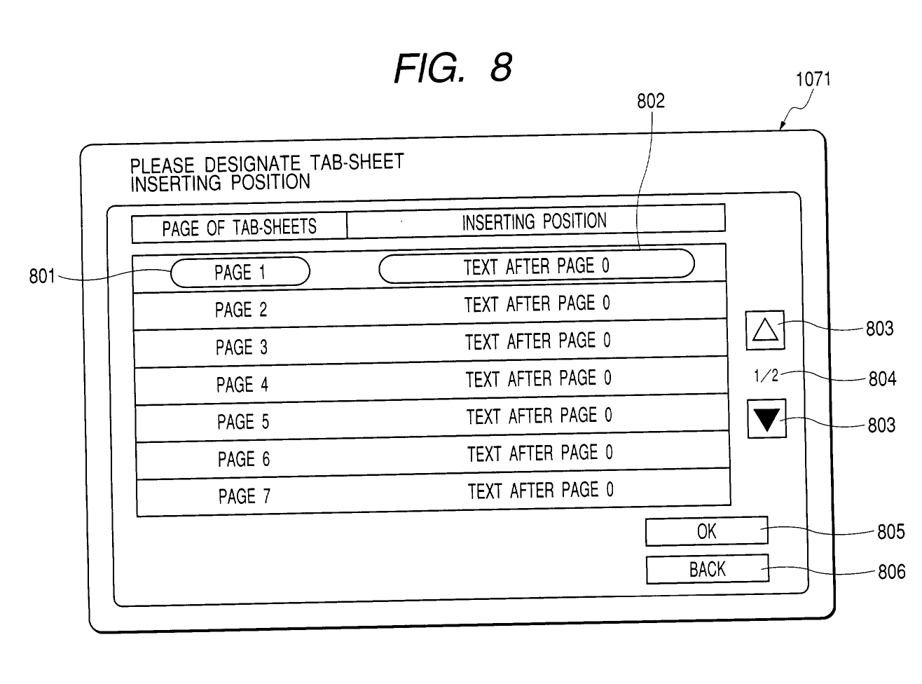

The CPU 301 is also connected with the operation unit 107 that was mentioned before with reference to FIG. 1, so that a display unit 1071 (see FIGS. 7 and 8) and a key entry unit (not shown) of the operation unit 107 are controlled by the CPU 301. The operator can designate, for the CPU 301, switching of an image forming operation mode, an original reading mode, print output mode, etc. on display with the key entry unit, in response to which the CPU 301 provides display of status of the digital copying machine or display for operation mode setting to be effected by key entry.

The CPU 301 is further connected with an image processing unit 306, which corresponds to the image processing means 102 shown in FIG. 1. The image processing device 306 converts an analog electrical signal corresponding to the image of the original output from a document sheet reading unit 305 (corresponding to the original reading means 101 in FIG. 1) comprised of the above-described reader unit 200 and ADF 280, into a form with which a printing unit 308 (corresponding to the printing means 106 in FIG. 1) comprised of the above-described image forming section 209 and recording sheet conveying mechanism can print on recording sheets. Details of this conversion will be described later.

The image processing unit 306 is connected with a image memory 307, which corresponds to the image storing means 105 in FIG. 1. The image memory 307 comprises a high-speed page memory and a hard disk with a large storage space capable of storing image data of a plurality of documents (text sheet documents or tab-sheet documents). The image data of the plurality of documents stored in the hard disk are output in accordance with an order corresponding to an edit mode designated by the operation unit 107. For example, in a case of an electronic sorting, a process in which document image data of a stack of originals set in the ADF 280 is read and sequentially stored in the hard disk and then the image data is read out for image formation, is repeated plural times. Thus, a function similar to a sorter having a plurality of bins can be attained.

Furthermore, CPU 301 is connected with an external interface 309, which corresponds to the external interface means 104 in FIG. 1. The external interface 309 receives image data of documents from a host apparatus through a network (not shown) or by conducting direct data communication with an external host apparatus such as a personal computer (not shown). Such image data is also stored in the hard disk of the image memory 307.

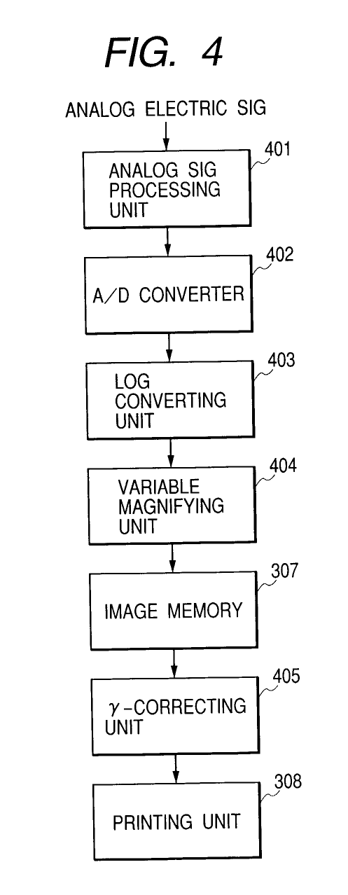

Next, details of the image processing unit 306 will be described with reference to FIG. 4. The image processing unit 306 is comprised of portions designated with reference numerals 401 through 405 in FIG. 4.

An original image formed on the CCD sensor in the image sensor unit 208 in FIG. 2 is converted by the CCD sensor into an analog signal corresponding to brightness of black of the image.

The analog electrical signal is input to an analog signal processing unit 401 shown in FIG. 4 and subjected to signal processing such as sample-and-hold and dark level correction, and then subjected to A/D (analog to digital) conversion in an A/D converter 402. The digitized signal is subjected to shading correction (i.e. compensation for non-uniformity in characteristics of the CCD sensor that senses the original image and light distribution characteristics of the lamp for illuminating the original) and thereafter input to a log converting unit 403.

In the log converting unit 403, a LUT (look-up-table) for converting brightness data of the input digital signal into density data is stored. The log converting unit 403 outputs, based on the LUT, density data table values corresponding to the brightness data of the input digital signal so as to convert the brightness data into the density data.

The image data in the form of the density data is input to a variable magnifying unit 404 so as to be scaled at a desired magnification, and then stored in the image memory 307.

At the time of image formation (or printing), image data is read out from the image memory 307 and input to a γ-correcting unit 405. The γ-correcting unit 405 conducts, upon outputting the image data (density data) to a printing unit 308, conversion based on a LUT that takes characteristics of the printing unit 308 into account. The γ-correcting unit 405 also conducts adjustment of output in accordance with density value set in the operation unit 107, and then sending the image data to the printing unit 308. The printing unit 308 forms an image on a recording sheet based on the image data in accordance with the image forming operation described before.

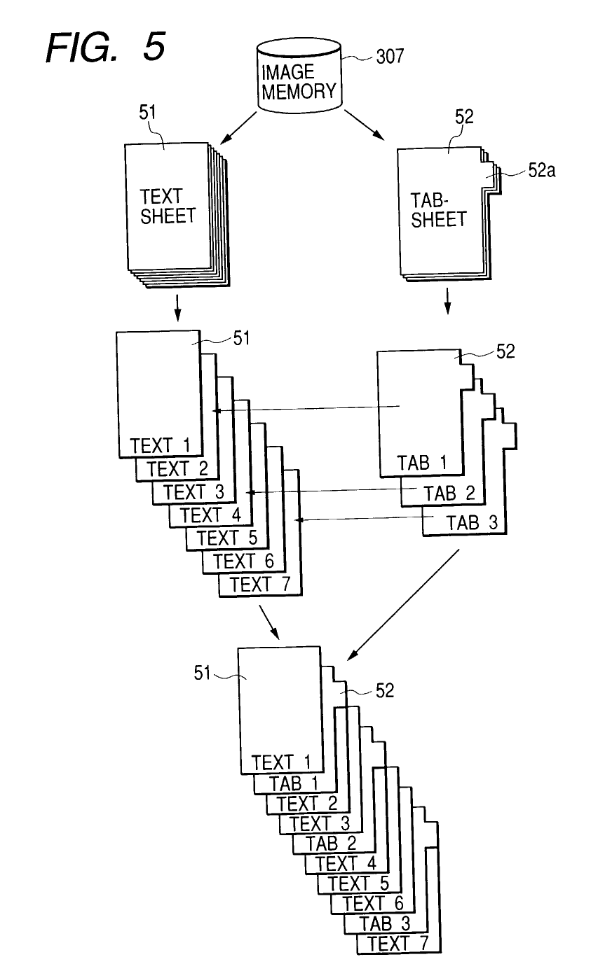

Next, the operation of the tab document combined printing according to the present invention in the digital copying machine of this embodiment will be described with reference to FIGS. 5 to 9.

First, the outlines of the operation of the tab-sheet combined printing will be described with reference to FIG. 5. As a precondition for the tab document combined printing, image data of at least one text sheet document to be printed on text sheets 51 and image data of at least one tab-sheet document to be printed at least on the tab portions 52a of tab-sheets 52 are stored in the image memory 307 in advance. Those document image data stored in the image memory 307 are those that have been input either through the document sheet reading unit 305 and image processing unit 306 or through the external interface 309 from an external host apparatus.

The tab document combined printing is a procedure in which one text sheet document and one tab-sheet document are combined so as to be printed, wherein the printing of each page (shown as TAB 1 to TAB 3 in FIG. 5) of the one tab-sheet document on the tab-sheet 52 is performed at a designated page position intervening in the printing of the one text sheet document (shown as TEXT 1 to TEXT 7 in FIG. 5).

Upon conducting the tab-sheet combined printing, the operator initially selects, from among the documents in connection with the image data stored in the image memory 307, one text sheet document to be subjected to the tab-sheet combined printing and one tab-sheet document. The operator also designates pages of the text sheet document at which respective pages of the tab-sheet document are to be inserted in the tab-sheet combined printing (the thus designated pages will be referred to as “tab-sheet inserting positions” hereinafter). For example, the tab-sheet inserting positions are designated in the manner as “after page 1”, “after page 3” and “after page 6”, as shown in FIG. 5.

In accordance with the designations, the digital copying machine prints images according to the image data of the designated text sheet document on the normal sheets 51 and prints images according to the designated tab-sheet document on the tab-sheets 52. In connection with this, upon performing the printing of the text sheet document, every time a designated page of a tab-sheet inserting position is printed on a normal sheet 51, a page of the tab-sheet document is printed on a tab-sheet 52.

As per the above, the tab-sheets 52 printed with the pages of the tab-sheet document are automatically inserted at the designated pages in the stack of the normal sheets 51 printed with the text sheet document.

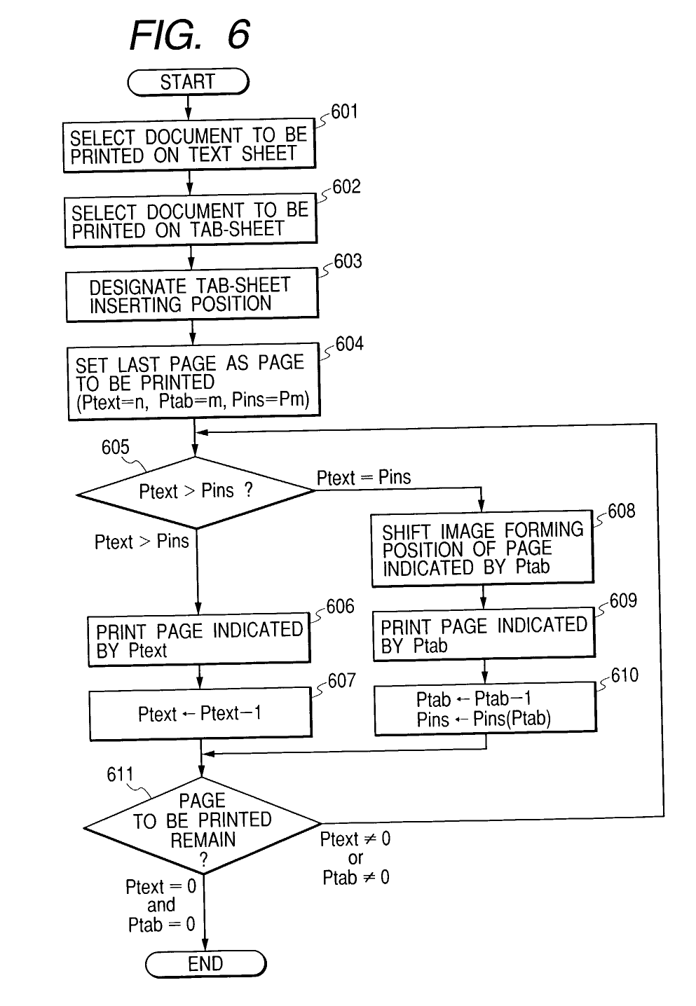

Next, details of the operation of the tab-sheet combined printing will be described with reference to FIG. 6. FIG. 6 is a flow chart illustrating a control process of CPU 301 for conducting the tab-sheet combined printing operation. A control program corresponding to this control process is stored in the ROM 303 and executed by the CPU 301. The ROM 303 is an embodiment of a computer-readable storage medium storing a control program for image forming apparatus according to the present invention. In the following description, the page numbers of the text sheet document designated for the tab document combined printing will be denoted with character n and the page numbers of the tab-sheet document will be denoted with character m.

When the tab document combined printing mode is selected by an operation of the operation unit 107, the CPU starts a process shown in FIG. 6. In step 601, the CPU causes the display unit 1071 of the operation unit 107 to display a selection screen (or window) for the text sheet document shown in FIG. 7, which allows (or prompts) the operator to designate one text sheet document to be subjected to the tab document combined printing, among the text sheet documents stored in the image memory 307.

In FIG. 7, the displayed document names 701 indicate the names of the documents stored in the image memory 307. The displayed sizes 702 indicate the sizes of recording sheets to be printed with the respective documents, the number of pages of the documents and the information on the surfaces to be printed (single side/dual side). The displayed date/times 703 indicate the dates and times at which respective documents were stored in the image memory 307. Reference numeral 704 denotes up and down scrolling buttons. Reference numeral 705 denotes the current/total pages of the selection screen on display. Reference numeral 706 denotes a button for finalizing the document selection and reference numeral 707 denotes a button for returning from the document selection screen to the previous screen. The display unit 1071 is comprised of a touch panel, so that the operator can select one text sheet document to be subjected to the tab-sheet combined printing by operating the buttons 704 and 706. The identification information for the one text sheet document thus selected is stored in the RAM 304.

In step 602, the CPU 301 causes the display unit 1071 to display a selection screen for the tab-sheet document similar to the selection screen for the text sheet document described above. The selection screen for the tab-sheet document allows (or prompts) the operator to designate one tab-sheet document to be subjected to the tab-sheet combined printing, among the tab-sheet documents stored in the image memory 307. The identification information for the one tab-sheet document thus selected is also stored in the RAM 304.

In step 603, the CPU causes the display device 1071 to display a designation screen for the tab-sheet inserting positions shown in FIG. 8, which allows (or prompts) the operator to designate the tab-sheet inserting positions of the respective pages of the tab-sheet document designated in step 602 with respect to the text sheet document designated in step 601.

In FIG. 8, the displayed pages of tab-sheets 801 indicate pages X (i.e. X-th pages) of the tab-sheet document. The displayed tab-sheet inserting positions 802 indicate the pages of the text sheet document at which the pages of the tab-sheet document displayed as the pages of tab-sheets 801 are to be inserted intervening in the printing of the text sheet document. The displayed pages 802 of tab-sheet inserting positions can be set as desired by operating a numeric keypad of a key entry unit (not shown) in the operation unit 107. Reference numeral 803 denotes up and down scrolling buttons for the displayed information 801 and 802. Reference numeral 804 denotes the current/total pages of the selection screen on display. Reference numeral 805 denotes a button for finalizing the designation of the tab-sheet inserting positions and reference numeral 806 denotes a button for returning from the designation screen to the previous screen. The tab-sheet inserting positions for respective pages of the tab-sheet document can be set by manipulating the buttons 803, numerical keypad and button 805. Here, the page numbers Pins of the tab-sheet inserting positions of the tab-sheet document, which have been designated as the inserting positions 802, will be expressed as P1, P2, P3, . . . , Pm. This information is stored in the RAM 304.

Upon completion of the designations of the tab-sheet inserting positions in step 603, the CPU read out the image information of the text sheet document and tab-sheet document designated in steps 601 and 602 from the image memory 307 so as to perform the tab document combined printing following the order in accordance with the information of the tab-sheet inserting positions designated in step 603. At the time of the printing, since it is impossible to reverse the surfaces of tab-sheets when they are discharged, the printing is performed in the order starting from the last page, taking into account the stacking order of the normal sheets and tab-sheets after they are discharged. Since the two documents are combined to be printed, it is necessary to determine pages to be printed in accordance with the designations of the tab-sheet inserting positions. Therefore, a comparison between a page (Ptext) to be printed of the text sheet document and a page (Pins) of the inserting position of a page (Ptab) to be printed of the tab-sheet document is conducted and the page that should be the later in the completed document is printed first, so that tab-sheets printed with the tab-sheet document would be inserted at the designated positions in a stack of normal sheets printed with the text sheet document.

In order to perform the tab document combined printing in the manner described above, in step 604, initial values for respective parameters are set as Ptext=n, Ptab=m and Pins=Pm so as to start the printing from the last page.

In step 605, a comparison between the page to be printed Ptext of the text sheet document and the page Pins of the tab-sheet inserting position is conducted. When Ptext>Pins, the process proceeds to step 606, in which in order to print the page of the text sheet document instead of the page of the tab-sheet document, the image information of the page to be printed Ptext of the text sheet document is output to the printing unit 308 so as to be printed. In doing so, the printing unit 308 feeds a normal sheet of a standard size so as to print the image information of the page to be printed Ptext of the text sheet document on that normal sheet which is fed. After that, in step 607, the value of the page to be printed Ptext of the text sheet document is decremented by 1 for next printing.

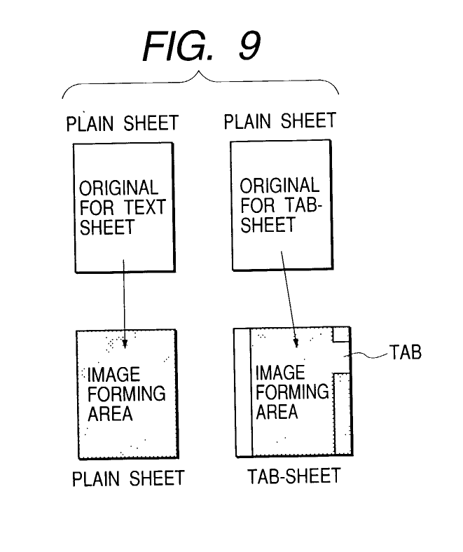

On the other hand, when Ptext=Pins in step 605, since that result of comparison indicates that the page to be printed is at the tab-sheet inserting position, printing of the page Ptab of the tab-sheet document is to be conducted. Before conducting the printing of the page Ptab of the tab-sheet document, in step 608, the image forming area for the page Ptab of the tab-sheet document is shifted by an amount corresponding to the extension amount of the tab from the edge of the tab-sheet so that an image can be printed on the tab of the tab-sheet as shown in FIG. 9. This shift may be attained by so constructing the machine that the operator can set the shift amount in advance by manipulating a key entry unit of the operation unit 107 so as to shift the area by a set amount. Then in step 609, the image of the page Ptab of the tab-sheet document is output to the printing unit 308 so as to be printed. In doing so, the printing unit 308 feeds a tab-sheet so as to print the image information of the page to be printed Ptab of the tab-sheet document on that tab-sheet which is fed. After that, in step 610, the value of the page to be printed Ptab of the tab-sheet document is decremented by 1 for next printing, and the page number Pins of the tab-sheet inserting position is updated to the number Pins(Ptab) corresponding to the page Ptab after the decrement (namely, Pins is updated from Pm to Pm−1).

Incidentally, it sould be noted that in step 605, the situation Ptext<Pins will not occur.

After step 607 and step 610, the process proceeds to step 611, in which it is confirmed whether or not both Ptext and Ptab are equal to 0 (zero). If in the negative (i.e. either of Ptext or Ptab is not 0), pages of text sheet document or tab-sheet document sill remain to be printed, and the process returns to step 605, so that the procedures according to steps 605 to 610 are repeated. When the printing of all of the pages of the text sheet document and tab-sheet document are completed by the repetition of the above steps, the process of tab document combined printing is terminated.

As described above, according to this embodiment of the invention, the tab document combined printing, which is a mixed printing job including printing of images for normal sheets and printing of images for tab-sheets, can be performed automatically. Furthermore, since such text sheet documents and tab-sheet documents that are stored in the image memory 307 in advance are designated to be used for the tab document combined printing, the image information of the text sheet documents and tab-sheet documents can be used a number of times for different printing jobs, and the image information of the text sheet documents and the image information of the tab-sheet documents can be used independently at any combination thereof. So the information of those documents would be utilized efficiently. Still further, it is not necessary to prepare a combined single document including the text sheet document and tab-sheet document, but the image information of the text sheet document and image information of the tab-sheet document can be prepared separately. So the preparation of documents would be easy.

(Another Embodiment)

In the above-described tab document combined printing, a text sheet document and a tab-sheet document that are designated respectively from among the text sheet documents and the tab-sheet documents having been stored in the image memory 307 in advance are subjected to the combined printing. But the above-described digital copying machine may be so modified that the combined printing would be performed with image information of one text sheet document that is freshly input so as to be stored in the image memory 307 and image information of one tab-sheet document that is designated from among the tab-sheet documents stored in the image memory 307 in advance. Such combined printing will be referred to as combined printing of tab-addition mode hereinafter and described in the following.

In the combined printing of the tab-addition mode, image information of at least one tab-sheet document should have been input to be stored in the image memory 307 in advance from the document sheet reading unit 305 or from a host apparatus via the external interface 309.

Upon performing the combine printing of the tab-addition mode, the operator set originals of a text sheet document on the document sheet reading unit 305 so as to have the image information of the text sheet document read and stored in the image memory 307. Then like the above described process of step 602 in FIG. 6, one tab-sheet document to be subjected to the combined printing is selected to be designated from among the tab-sheet document stored in the image memory 307. And then like the above-described process of step 603, the tab-sheet inserting positions are designated, so that the printings of respective pages of the tab-sheet document is inserted in the printing of the text sheet document that have been read by the document sheet reading unit 305 and stored in the image memory 307. After that, the combined printing is performed following the process same as the above-described process of steps 606 to 611.

In the combined printing of the tab-addition mode described above, it is necessary for the operator to designate the tab-sheet document to be subjected to the combined printing, but not necessary to designate the text sheet document.

On the other hand, conversely to the combined printing of the tab-addition mode described above, the combined printing may also be performed with image information of one tab-sheet document that is freshly input so as to be stored in the image memory 307 and image information of one text sheet document that is designated from among text sheet documents having been stored in the image memory 307 in advance. It would be appreciated that the printing process of this alternative combined printing would be apparently described by interchanging the wording “tab-sheet document(s)” and “text sheet document(s)” in the above description.

In the above-described embodiments, the text sheet document(s) and the tab-sheet document(s) need not to be input through the same inputting means. Namely it is possible to arrange that the text sheet document(s) be input through the external interface means 104 or the external interface 309, while the tab-sheet document(s) be input through the original reading means 101 or the document sheet reading unit 305. It is also possible to arrange that the text sheet document(s) be input through the original reading means 101 or the document sheet reading unit 305, while the tab-sheet document(s) be input through the external interface means 104 or the external interface 309.

As will be appreciated from the above descriptions, in the image forming apparatus that is adapted to be capable of printing images on recording sheets in the form of tab-sheets as well as normal sheets of standard sizes, it is possible to perform such combined printing as a mixed printing job including printing of images for normal sheets and printing of images for tab-sheets automatically, in which one text sheet document and one tab-sheet document that have been separately input to and separately stored in image memory means are combined to be so printed that printings of the pages of the one tab-sheet document are inserted intervening in the printing of the pages of the one text sheet document at respective designated page number positions. The image information of the text sheet documents and tab-sheet documents can be used a number of times for different printing jobs, and the image information of the text sheet documents and the image information of the tab-sheet documents can be used independently at any combination thereof. So the information of those documents would be utilized efficiently. Furthermore, it is not necessary to prepare a combined single document including a text sheet document and a tab-sheet document, but the image information of a text sheet document and image information of a tab-sheet document can be prepared separately. So an advantageous effect that documents can be prepared easily would be attained.

It is to be understood that the phraseology or terminology employed herein is for the purpose of description and not of limitation.

While the invention has been described with reference to the embodiments disclosed herein, it is not confined to the details set forth and this application is intended to cover such modifications or changes as may come within the purposes of the improvements or the scope of the following claims.

What is claimed is:

1. An image forming apparatus comprising:
an image memory unit which stores image information of a text sheet document to be printed on normal sheets of a standard size and image information of a tab-sheet document to be printed on tab-sheets;
a printing unit which performs printing of said image information of the text sheet document stored in the image memory unit on said normal sheets and printing of said image information of the tab-sheet document stored in the image memory unit on said tab-sheets; and
a control unit which controls said printing unit in such a way that the printing unit performs combined printing in which printing of the image information of the text sheet document stored in said image memory unit and printing of the image information of the tab-sheet document stored in said image memory unit are so combined that the printing of each page of said tab-sheet document is inserted intervening in the printing of said text sheet document.

2. An image forming apparatus according to claim 1, further comprising:
document designating means for allowing an operator to designate a text sheet document and a tab-sheet document to be subjected to said combined printing respectively from among the text sheet document and the tab-sheet document stored in said image memory unit; and
inserting page designating means for allowing the operator to designate, in said combined printing, pages in the printing of the text sheet document at which printings of respective pages of said tab-sheet document are to be inserted;
wherein said control unit controls said printing unit in such a way that the combined printing of the text sheet document and the tab-sheet document designated by said document designating means is performed following an order in accordance with the designation of the inserting pages designated by said inserting page designating means.

3. An image forming apparatus according to claim 1, further comprising:
document designating means for allowing an operator to designate a tab-sheet document to be subjected to said combined printing from among the tab-sheet document stored in said image memory unit; and
inserting page designating means for allowing the operator to designate, in said combined printing, pages in the printing of the text sheet document at which printings of respective pages of said tab-sheet document are to be inserted;
wherein said control unit controls, upon performing said combined printing, said printing unit in such a way that the combined printing of a text sheet document that is freshly input through an image inputting unit and stored in said image memory unit and the tab-sheet document designated by said document designating means is performed following an order in accordance with the inserting pages designated by said inserting page designating means.

4. An image forming apparatus according to claim 1, further comprising:
document designating means for allowing an operator to designate a text sheet document to be subjected to said combined printing from among the text sheet document stored in said image memory unit; and
inserting page designating means for allowing the operator to designate, in said combined printing, pages in the printing of the text sheet document at which printings of respective pages of said tab-sheet document are to be inserted;
wherein said control unit controls, upon performing said combined printing, said printing unit in such a way that the combined printing of a tab-sheet document that is freshly input through an image inputting unit and stored in said image memory unit and the text sheet document designated by said document designating means is performed following an order in accordance with the inserting pages designated by said inserting page designating means.

5. An image forming apparatus according to claim 1, wherein when an image of each page of said tab-sheet document is printed on said tab-sheet, said control unit controls to shift an image forming position of that image so that the image would be printed on a tab of said tab-sheet.

6. An image forming apparatus according to claim 5, further comprising designation means for allowing an operator to designate a shift amount of said image forming position.

7. An image forming apparatus according to claim 1, further comprising an image inputting unit for inputting image information of said text sheet document and image information of said tab-sheet document.

8. An image forming apparatus according to claim 7, wherein said image inputting unit inputs the image information of said text sheet document and image information of said tab-sheet document separately.

9. An image forming apparatus according to claim 7, wherein said image inputting unit comprises an document sheet reading unit which reads the image information of an original of said text sheet document or the image information of an original of said tab-sheet document.

10. An image forming apparatus according to claim 7, wherein said image inputting unit comprises an external interface unit which communicates with an external host apparatus to receive the image information of said text sheet document or the image information of said tab-sheet document from the host apparatus.

11. An image forming apparatus according to claim 1, further comprising:
a first image inputting unit which inputs the image information of said text sheet document; and
a second image inputting unit which inputs the image information of said tab-sheet document.

12. A control method for an image forming apparatus adapted to be capable of printing images on recording sheets in the form of tab-sheets as well as on normal sheets of a standard size and having a memory for storing image information of a text sheet document to be printed on said normal sheets and image information of a tab-sheet document to be printed on said tab-sheets, the method comprising the steps of:
inputting image information of said text sheet document;
inputting image information of said tab-sheet document;
storing the image information of said text sheet document and the image information of said tab-sheet document in said memory; and
performing combined printing in which printing of the image information of the text sheet document stored in said image memory and printing of the image information of the tab-sheet document stored in said image memory are so combined that the printing of each page of said tab-sheet document is inserted intervening in the printing of said text sheet document.

13. A control method for an image forming apparatus according to claim 12, further comprising the steps of:
receiving a document designation by an operator for designating a text sheet document and a tab-sheet document to be subjected to said combined printing from among the text sheet document and the tab-sheet document stored in said memory;
receiving a inserting page designation by the operator for designating, in said combined printing, pages in the printing of said text sheet document at which printings of respective pages of said tab-sheet document are to be inserted; and
controlling to perform the combined printing of the designated text sheet document and the designated tab-sheet document following an order in accordance with the designated inserting pages.

14. A control method for an image forming apparatus according to claim 12, further comprising the steps of:
receiving a document designation by an operator for designating a tab-sheet document to be subjected to said combined printing from among the tab-sheet document stored in said memory;
receiving a inserting page designation by the operator for designating, in said combined printing, pages in the printing of said text sheet document at which printings of respective pages of said tab-sheet document are to be inserted; and
controlling to perform, upon performing said combined printing, the combined printing of a text sheet document that is freshly input through an image inputting unit and stored in said image memory unit and the designated tab-sheet document following an order in accordance with the designated inserting pages.

15. A control method for an image forming apparatus according to claim 12, further comprising the steps of:
receiving a document designation by an operator designating a text sheet document to be subjected to said combined printing from among the text sheet document stored in said image memory unit;
receiving a inserting page designation by the operator for designating, in said combined printing, pages in the printing of the text sheet document at which printings of respective pages of said tab-sheet document are to be inserted; and
controlling to perform, upon performing said combined printing, the combined printing of a tab-sheet document that is freshly input through an image inputting unit and stored in said image memory unit and the designated text sheet document following an order in accordance with the designated inserting pages.
